(19) United States
(12) Patent Application Publication
(10) Pub. No.: US 2004/0020188 A1
(43) Pub. Date: Feb. 5, 2004

(54) Method and apparatus for generating pressurized air by use of reformate gas from a fuel reformer

(76) Inventors: Dennis A. Kramer, Troy, MI (US); Navin Khadiya, Columbus, IN (US)

Correspondence Address: BARNES & THORNBURG, 11 SOUTH MERIDIAN, INDIANAPOLIS, IN, 46204

(21) Appl. No.: 10/612,313

(22) Filed: Jul. 2, 2003

Related U.S. Application Data
(60) Provisional application No. 60/401,095, filed on Aug. 5, 2002.

(51) Int. Cl. F02B 43/08; F01N 3/00

(52) U.S. Cl. 60/275; 123/3

(57) ABSTRACT

A method of operating a power system includes operating a fuel reformer so as to produce a reformate gas. The reformate gas is advanced through a turbine of a turbocharger thereby driving the compressor of the turbocharger. Pressurized air generated by the compressor is supplied to the air inlet of the fuel reformer. The reformate gas exiting the turbine of the turbocharger is advanced to a component such as the intake of the engine, an emission abatement device, or a fuel cell. A fuel reforming system operated by such a method is also disclosed.

This application claims priority to U.S. Provisional Patent Application Serial No. 60/401,095 which was filed on Aug. 5, 2002, the disclosure of which is hereby incorporated by reference.

### CROSS REFERENCE TO RELATED APPLICATIONS

Cross reference is made to copending U.S. patent application Ser. No. ______ (Attorney Docket No. 9501-72887) entitled “Method and Apparatus for Advancing Air into a Fuel Reformer by Use of an Engine Vacuum,” along with copending U.S. patent application Ser. No. ______ (Attorney Docket No. 9501-72886) entitled “Method and Apparatus for Advancing Air into a Fuel Reformer by Use of a Turbocharger,” both of which are assigned to the same assignee as the present application, filed concurrently herewith, and hereby incorporated by reference.

### FIELD OF THE DISCLOSURE

The present disclosure relates generally to onboard fuel reforming systems and methods of operating onboard fuel reforming systems.

### BACKGROUND OF THE DISCLOSURE

A fuel reformer is operated to reform a hydrocarbon fuel into a reformate gas. In the case of an onboard fuel reformer such as a fuel reformer associated with a vehicle or a stationary power generator, the reformate gas produced by the fuel reformer may be utilized as fuel or fuel additive in the operation of an internal combustion engine. The reformate gas may also be utilized to regenerate or otherwise condition an emission abatement device associated with an internal combustion engine or as a fuel for a fuel cell.

### SUMMARY OF THE DISCLOSURE

According to one aspect of the disclosure, a fuel reforming system includes an expander that is driven by a flow of reformate gas from a fuel reformer. The output of the expander drives a compressor that produces pressurized air for use by the fuel reformer.

According to another aspect of the disclosure, a fuel reforming system includes a turbocharger and a fuel reformer. The turbocharger has a pressurized air outlet that is fluidly coupled to an air inlet of the fuel reformer and a reformate gas inlet that is fluidly coupled to a reformate gas outlet of the fuel reformer. The turbocharger has a turbine that is driven by a flow of reformate gas from the fuel reformer. The turbine drives a compressor to provide the pressurized air to the fuel reformer. The outlet of the turbine is fluidly coupled to a component such as the intake of the engine, an emission abatement device, or a fuel cell.

According to another aspect of the disclosure, a method of operating a power system includes advancing reformate gas from a fuel reformer through the turbine of a turbocharger so as to produce pressurized air. The pressurized air is supplied to the air inlet of the fuel reformer. The reformate gas exiting the turbine of the turbocharger is advanced to a component such as the intake of the engine, an emission abatement device, or a fuel cell.

### BRIEF DESCRIPTION OF THE DRAWINGS

FIG. 1 is a simplified block diagram of a fuel reforming system having a fuel reformer and an expander/compressor assembly;

FIG. 2 is a simplified block diagram similar to FIG. 1, but showing the expander/compressor embodied as a turbocharger; and

FIGS. 3-5 are simplified block diagrams of the various components that receive the reformate gas produced by the fuel reformer.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

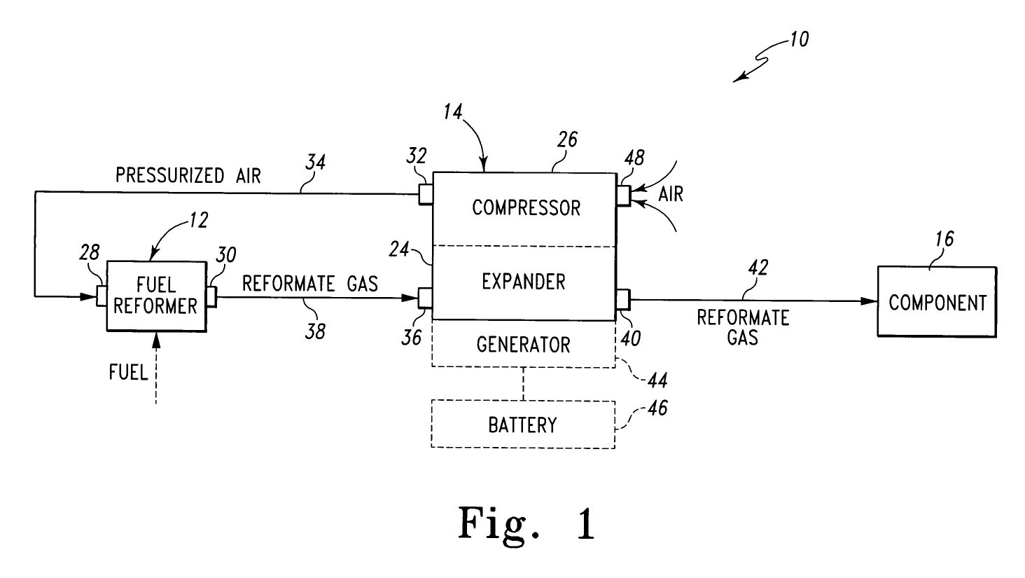

Referring now to FIG. 1, there is shown a fuel reforming system 10 having a fuel reformer 12 and an expander/compressor assembly 14. The fuel reformer 12 described herein may be embodied as any type of fuel reformer such as, for example, a catalytic fuel reformer, a thermal fuel reformer, a steam fuel reformer, or any other type of partial oxidation fuel reformer. The fuel reformer 12 of the present disclosure may also be embodied as a plasma fuel reformer. A plasma fuel reformer uses plasma to convert a mixture of air and hydrocarbon fuel into a reformate gas which is rich in, amongst other things, hydrogen gas and carbon monoxide. Systems including plasma fuel reformers are disclosed in U.S. Pat. No. 5,425,332 issued to Rabinovich et al.; U.S. Pat. No. 5,437,250 issued to Rabinovich et al.; U.S. Pat. No. 5,409,784 issued to Bromberg et al.; and U.S. Pat. No. 5,887,554 issued to Cohn, et al., the disclosures of each of which is hereby incorporated by reference. Additional examples of systems including plasma fuel reformers are disclosed in copending U.S. patent application Ser. No. 10/158,615 entitled “Low Current Plasmatron Fuel Converter Having Enlarged Volume Discharges” which was filed on May 30, 2002 by A. Rabinovich, N. Alexeev, L. Bromberg, D. Cohn, and A. Samokhin, along with copending U.S. patent application Ser. No. 10/411,917 entitled “Plasmatron Fuel Converter Having Decoupled Air Flow Control” which was filed on Apr. 11, 2003 by A. Rabinovich, N. Alexeev, L. Bromberg, D. Cohn, and A. Samokhin, the disclosures of both of which are hereby incorporated by reference.

For purposes of the following description, the concepts of the present disclosure will herein be described in regard to a plasma fuel reformer. However, as described above, the fuel reformer of the present disclosure may be embodied as any type of fuel reformer, and the claims attached hereto should not be interpreted to be limited to any particular type of fuel reformer unless expressly defined therein.

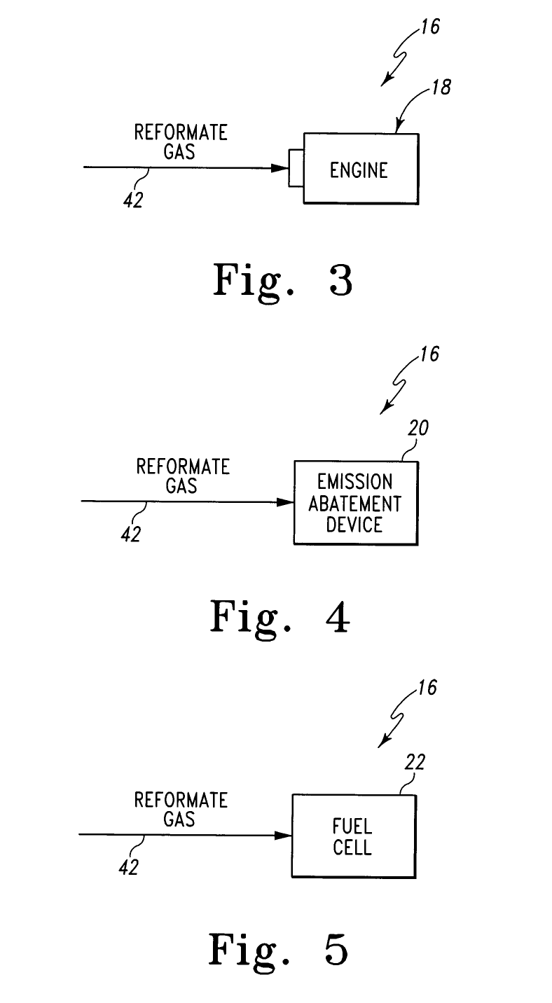

The plasma fuel reformer 12 may be used in the construction of an onboard fuel reforming system of a vehicle or a stationary power generator. The reformate gas produced by the onboard plasma fuel reformer 12 may be supplied to a component 16 associated with a vehicle or stationary power generator. For example, the reformate gas produced by the fuel reformer may be utilized as fuel or fuel additive in the operation of an internal combustion engine 18 (see FIG. 3) thereby increasing the efficiency of the engine while also reducing emissions produced by the engine. The reformate gas produced by the onboard plasma fuel reformer 12 may also be utilized to regenerate or otherwise condition an emission abatement device 20 (see FIG. 4) associated with an internal combustion engine. In addition, if the vehicle or the stationary power generator is equipped with a fuel cell 22 such as, for example, an auxiliary power unit (APU), the reformate gas from the onboard plasma fuel reformer 12 may also be used as a fuel for the fuel cell 22 (see FIG. 5).

The plasma fuel reformer 12 processes a mixture of fuel and air to produce the reformate gas. The fuel may be any type of hydrocarbon fuel such as gasoline or diesel fuel. In an exemplary embodiment, the fuel reformed by the plasma fuel reformer 12 is the same type of fuel being combusted by the engine of the vehicle or stationary power generator.

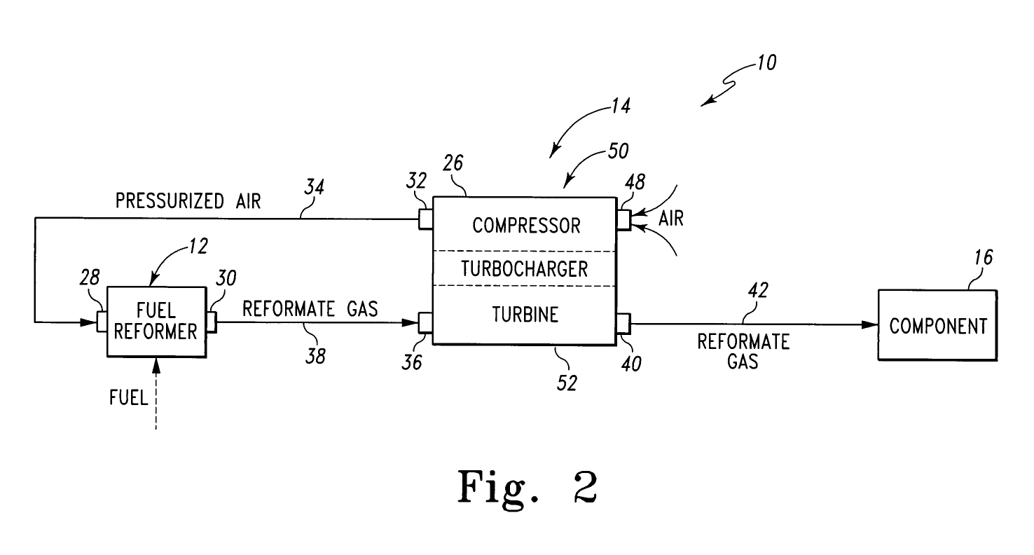

The expander/compressor assembly 14 includes an expander 24 and a compressor 26. The expander 24 may be embodied as any type of expander that generates mechanical output as a result of a heated fluid flow therethrough. For example, as discussed below in greater detail in regard to FIG. 2, the expander 24 may be embodied as a turbine. In this case, a flow of hot reformate gas from the fuel reformer 12 drives the turbine to produce mechanical output.

Alternatively, the expander 24 may be embodied as a piston-type expander. In this case, hot reformate gas from the fuel reformer 12 drives a number of pistons which in turn produce mechanical output. Examples of piston-type expanders are found in U.S. Pat. Nos. 6,283,723; 5,114,321; 5,004,404; and 4,907,950, each of which is hereby incorporated by reference. Assemblies having an integrated piston-type expander and compressor may also be utilized as the expander 24 (and the compressor 26). Such integrated assemblies are described in U.S. Pat. No. 6,283,723 and commercially available from Vairex Corporation of Boulder, Colo.

The expander 24 may also be embodied as other types of expanders such as a screw type expander, a scroll-type compressor/expander, a hybrid compressor/expander (e.g., a combination turbocompressor and scroll compressor/expander), or a positive displacement novel geometry expander.

Mechanical output from the expander 24 drives the compressor 26 so as to produce pressurized air. In particular, the output of the expander 24 is mechanically coupled to the compressor 26 so as to drive the compressor. In such a way, air admitted to the compressor 26 through an air inlet 48 is pressurized and thereafter supplied to the plasma fuel reformer 12.

The plasma fuel reformer 12 includes an air inlet 28 for admitting pressurized air into the fuel reformer 12 and a reformate gas outlet 30 for discharging the reformate gas from the fuel reformer 12. It should be appreciated that although the plasma fuel reformer 12 is described herein as having only a single air inlet (i.e., the air inlet 28), the fuel reformer 12 may be embodied with any number of air inlets including a number of air inlets having decoupled flows. The air inlet 28 is fluidly coupled to a pressurized air outlet 32 of the compressor 26 via a fluid line 34.

The expander 24 has a reformate gas inlet 36 for admitting the reformate gas from the plasma fuel reformer 12. A fluid line 38 couples the reformate gas outlet 30 of the plasma fuel reformer 12 to the reformate gas inlet 36 of the expander 24. A reformate gas outlet 40 of the expander 24 is fluidly coupled to the system component 16 via a fluid line 42. As alluded to above, the system component 16 may take the form of an intake of an engine 18 such as a gasoline, spark-ignited engine. In such a case, the reformate gas is utilized as a fuel or fuel additive for the engine 18.

The system component 16 may also take the form of an emission abatement device 20 for treating the emissions of an internal combustion engine such as a diesel engine. The emission abatement device 20 may be embodied as a NO_{X} device such as a trap or SCR catalyst or other type of abatement device such as a particulate soot filter. In such a way, the device 20 is utilized to remove compounds such as NO_{X}, SO_{X}, or soot particles present in the exhaust gas discharged from an internal combustion engine.

The system component 16 may also take the form of a fuel cell 22. The fuel cell 22 may be embodied as any type of fuel cell. For example, the fuel cell may be embodied as an alkaline fuel cell (AFC), a phosphoric acid fuel cell (PAFC), a proton exchange membrane fuel cell (PEMFC), a solid oxide fuel cell (SOFC), a molten carbonate fuel cell (MCFC), or any other type of fuel cell.

In operation, the hot reformate gas produced by the plasma fuel reformer 12 is advanced through the expander 24 thereby driving the compressor 26. The reformate gas exiting the expander 24 is supplied to the system component 16 (e.g., the intake of the engine 18, the emission abatement device 20, or the fuel cell 22). Pressurized air generated by the compressor 26 is supplied to the inlet of the plasma fuel reformer 12 thereby providing the reformer's pressurized air requirements.

In addition to driving the compressor 26, the expander 24 may also be utilized to drive an electrical generator 44 (shown in phantom in FIG. 1). The generator 44 may be embodied as either a DC or AC generator based on system requirements. The energy produced by the generator 44 may be stored in a battery 46 for use by components associated with the vehicle or power generator. The generator 44 may be used in concert with the compressor 26, or, alternatively, may be used in lieu of the compressor 26 in which case the electrical energy generated by the generator 44 may be used to power, amongst other components, an electrically-driven compressor (not shown) for supplying pressurized air to the fuel reformer 12.

In addition, the expander/compressor assembly 14 may be configured with a drive motor (not shown). The drive motor may be utilized to provide auxiliary input power to the expander 24 to drive the compressor 26 during times when mechanical output from the expander alone is not sufficient to meet the pressurized air requirements of the fuel reformer 12. A closed-loop feedback mechanism may be used to selectively actuate and de-actuate the drive motor depending on whether or not the expander 24 is providing sufficient mechanical input to the compressor 26.

A heat exchanger (not shown) may be used between the outlet 30 of the fuel reformer 12 and the inlet 36 of the expander 24. In certain system designs, it may be desirable to cool the reformate gas prior to introduction into the expander 24.

Referring now to FIG. 2, there is shown a specific exemplary embodiment of the fuel reforming system 10. The system of FIG. 2 includes structures that are similar to the structures described above in regard to FIG. 1. The same reference numerals are used in FIG. 2 to refer to the like structures described above in FIG. 1 with additional discussion thereof being unwarranted.

In the system of FIG. 2, a turbocharger 50 is utilized as the expander/compressor assembly 14. The turbocharger 50 includes a turbine 52 for driving the compressor 26. Specifically, the turbine 52 has an output shaft (not shown) that is mechanically coupled to the compressor 26 thereby allowing the turbine 52 to drive the compressor 54.

In a similar manner to as described in regard to FIG. 1, the reformate gas outlet 30 of the plasma fuel reformer 12 is fluidly coupled to the inlet 36 of the turbine 52, with the outlet of the turbine 52 being fluidly coupled to the system component 16 (e.g., the intake of the engine 18, the emission abatement device 20, or the fuel cell 22). As such, the reformate gas produced by the fuel reformer 12 is used to drive the turbine 52 during advancement thereof from the fuel reformer 12 to the system component 16.

Pressurized air is supplied to the inlet 28 of the plasma fuel reformer 12 from the outlet 32 of the turbocharger's compressor 26. Specifically, unpressurized air admitted into the compressor 26 through the air inlet 48 is pressurized by the compressor 26 and advanced to the pressurized air inlet 28 of the fuel reformer 12 for use by the reformer 12.

The reformate gas provides the energy necessary to drive the compressor 26. Specifically, enough energy (enthalpy) is available in the reformate gases (based on a reformate temperature of 1100° K. being cooled down to 600° K. in the turbine 52) to compress the air to more than 20 bar. This is substantially greater that the reformer's actual requirement for compressed air of about 3 bar.

In addition, by cooling the reformate gas, the turbine 24 also functions, in essence, as a heat exchanger. As such, the need to use a separate heat exchanger for cooling the reformate gas prior to introduction to one of the system components 16 is eliminated. It should be noted, however, that in certain configurations it may be desirable to cool the reformate gas prior to introduction into the turbine 24 to extend the useful life of the turbine 52.

As described herein, the concepts of the present disclosure have a number of advantages. For example, compressed air is provided to the fuel reformer 12 without the use of an engine driven or electric compressor. This not only increases the operational efficiency of the system, but also reduces, if not eliminates, retrofit to the engine of the system. Moreover, air is supplied to the fuel reformer 12 in proportion to demand since the flow of hot reformate gas from the fuel reformer 12 increases contemporaneously with increases in the reformer's air requirement. Yet further, by use of the reformate gas from the fuel reformer to operate the expander (as opposed to, for example, exhaust gases from the engine or the fuel reformer), the reformate gas may be cooled prior to introduction to a system component 16 without the use of a heat exchanger.

While the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of operating a fuel reforming system, the method comprising the steps of:
operating a fuel reformer so as to produce a reformate gas,
advancing the reformate gas through a turbine of a turbocharger so as to produce pressurized air, and
advancing the pressurized air to an air inlet of the fuel reformer.

2. The method of claim 1, further comprising the step of advancing the reformate gas exiting the turbine to an intake of an internal combustion engine.

3. The method of claim 1, wherein:
the reformate gas comprises a hydrogen-rich gas, and
the reformate gas advancing step comprises advancing the hydrogen-rich gas through the turbine and to an intake of an internal combustion engine.

4. The method of claim 1, further comprising the step of advancing the reformate gas exiting the turbine to an emission abatement device.

5. The method of claim 1, wherein:
the reformate gas comprises a hydrogen-rich gas, and
the reformate gas advancing step comprises advancing the hydrogen-rich gas through the turbine and to an emission abatement device.

6. The method of claim 1, further comprising the step of driving an electrical generator with an output of the turbine.

7. The method of claim 1, wherein:
the turbocharger has a compressor coupled to the turbine, and
the reformate gas advancing step comprises driving the compressor with an output of the turbine.

8. The method of claim 1, wherein:
the fuel reformer comprises a plasma fuel reformer having an air inlet, and
the pressurized air advancing step comprises advancing the pressurized air through the air inlet of the plasma fuel reformer.

9. A fuel reforming system, comprising:
a turbocharger having (i) a turbine with a reformate gas inlet, and (ii) a compressor with a pressurized air outlet, and
a fuel reformer having (i) an air inlet fluidly coupled to the pressurized air outlet of the compressor, and (ii) a reformate gas outlet fluidly coupled to the reformate gas inlet of the turbine.

10. The system of claim 9, wherein the turbocharger has a reformate gas outlet fluidly coupled to an intake of an internal combustion engine.

11. The system of claim 9, wherein the turbocharger has a reformate gas outlet fluidly coupled to an emission abatement device.

12. The system of claim 9, further comprising an electrical generator having an input coupled to an output of the turbine.

13. The system of claim 9, wherein the fuel reformer comprises a plasma fuel reformer.

14. A fuel reforming system, comprising:
an expander having a reformate gas inlet,
a compressor mechanically coupled to the expander, the compressor having a pressurized air outlet, and
a fuel reformer having (i) an air inlet fluidly coupled to the pressurized air outlet of the compressor, and (ii) a reformate gas outlet fluidly coupled to the reformate gas inlet of the expander.

15. The system of claim 14, wherein the expander has a reformate gas outlet fluidly coupled to an intake of an internal combustion engine.

16. The system of claim 14, wherein the expander has a reformate gas outlet fluidly coupled to an emission abatement device.

17. The system of claim 14, further comprising an electrical generator having an input mechanically coupled to an output of the expander.

18. The system of claim 14, wherein the fuel reformer comprises a plasma fuel reformer.

19. The system of claim 14, wherein the expander is selected from a group consisting of a turbine, a piston-type expander, and a screw-type expander.
